(19) United States
(12) Patent Application Publication
(10) Pub. No.: US 2025/0178452 A1
(43) Pub. Date: Jun. 5, 2025

(54) TECHNIQUES FOR CONTROLLING A POWER DISSIPATION MODE OF AN ELECTRIFIED VEHICLE

(71) Applicant: FCA US LLC, Auburn Hills, MI (US)

(72) Inventors: Shu Wang, Lake Orion, MI (US); Joseph Falcon, Saline, MI (US)

(21) Appl. No.: 18/524,204

(22) Filed: Nov. 30, 2023

(51) Int. Cl. B60L 15/20; B60L 50/62; B60L 50/75

(52) U.S. Cl. CPC B60L 15/2045; B60L 15/2018; B60L 50/62; B60L 50/75; B60L 2200/36; B60L 2240/423; B60L 2240/443; B60L 2260/30

(57) ABSTRACT

A control system for an electrified powertrain of an electrified vehicle is configured to determine whether to enable/disable a power dissipation mode of the electrified powertrain and, when the power dissipation mode is enabled, determine a torque request for the electrified powertrain based on a driver torque request and a set of negative torque requestors, determine a target power dissipation based on the determined torque request, a regenerative torque capability of a regenerative braking system of the electrified powertrain, and a set of operating parameters of the electrified vehicle, determine an allocation or distribution of the target power dissipation between a set of power dissipation systems, and control the set of power dissipation systems to achieve the target power dissipation and thereby reduce a thermal load on a friction brake system of the electrified vehicle.

### FIELD

The present application generally relates to electrified vehicles (EVs) and, more particularly, to techniques for controlling a power dissipation mode of an EV.

### BACKGROUND

An electrified vehicle (EV) is propulsively powered by an electrified powertrain that includes one or more electric motors. The electric motors are powered by electrical energy (i.e., current) supplied from an energy storage system. The energy storage system could be a high voltage battery system, a fuel cell system, or some combination thereof. A fuel cell EV (FCEV) includes such a fuel cell system, whereas a range-extended EV (REEV), also referred to as a “range-extended paradigm breaker” (REPB), has an internal combustion engine, for propulsive torque and/or battery system recharging. For heavy-duty EV applications, such as heavy-duty pickup trucks that are capable of towing significant payloads, there is a desire to minimize the usage of conventional friction brakes (e.g., during downhill driving) to extend their life/usability. This is typically achieved by instead utilizing regenerative braking to recapture the vehicle's kinetic energy. In some scenarios, however, the energy storage system is “full” or at its capacity and thus regenerative braking cannot be utilized. Accordingly, while such conventional EV control systems do work well for their intended purpose, there exists an opportunity for improvement in the relevant art.

### SUMMARY

According to one example aspect of the invention, a control system for an electrified powertrain of an electrified vehicle is presented. In one exemplary implementation, the control system comprises a set of sensors configured to monitor a set of operating parameters of the electrified vehicle, each operating parameter of the set of operating parameters being related to the enablement/disablement of a power dissipation mode of the electrified powertrain and a control system configured to receive, from the set of sensors, the set of operating parameters, determine whether to enable/disable the power dissipation mode of the electrified powertrain based on the set of operating parameters, and determine a target power dissipation for the electrified powertrain and, when the power dissipation mode is enabled, control a set of power dissipation systems to achieve the target power dissipation and thereby reduce a thermal load on a friction brake system of the electrified vehicle.

In some implementations, the control system is further configured to optimize the target power dissipation based on a set of optimization parameters In some implementations, the control system is configured to optimize the target power dissipation by applying a hysteresis to limit a transition frequency between the enablement and disablement of the power dissipation mode, and wherein the applied hysteresis is based on the set of optimization parameters. In some implementations, the set of optimization parameters includes a weight of the electrified vehicle, a drive mode of the electrified vehicle, and an estimated duration of downhill travel by the electrified vehicle. In some implementations, the set of operating parameters includes a grade of a road that the electrified vehicle is on, a state of charge (SOC) of a high voltage battery system configured to supply electrical energy to at least one electric motor of the electrified powertrain, and a temperature of the friction brake system.

In some implementations, the set of operating parameters further includes a driver-controlled manual enablement request for the power dissipation mode, and wherein the controller is configured to enable the power dissipation mode without regard to a remainder of the set of operating parameters. In some implementations, the electrified vehicle is a fuel cell electrified vehicle (FCEV) and the electrified powertrain further includes a fuel cell system, and wherein the set of operating parameters includes a minimum power limit for generation by the fuel cell system. In some implementations, the minimum power limit for generation by the fuel cell system corresponds to hardware limits/constraints and/or durability concerns of the fuel cell system. In some implementations, the electrified vehicle is a range-extended electrified vehicle (REEV) and the electrified powertrain further includes an internal combustion engine, and wherein the set of operating parameters and the set of power dissipation systems each include the engine and its motoring. In some implementations, the engine motoring takes priority over a remainder of the set of operating parameters for enablement of the power dissipation mode and for usage as a power dissipation system.

According to another example aspect of the invention, a control method for an electrified powertrain of an electrified vehicle is presented. In one exemplary implementation, the control method comprises receiving, by a control system of and from the set of sensors of the electrified vehicle, a set of operating parameters of the electrified vehicle, each operating parameter of the set of operating parameters being related to the enablement/disablement of a power dissipation mode of the electrified powertrain, determining, by the control system, whether to enable/disable the power dissipation mode of the electrified powertrain based on the set of operating parameters, determining, by the control system, a target power dissipation for the electrified powertrain, and controlling, by the control system, a set of power dissipation systems to achieve the target power dissipation when the power dissipation mode is enabled and thereby reduce a thermal load on a friction brake system of the electrified vehicle.

In some implementations, the control method further comprises optimizing, by the control system, the target power dissipation based on a set of optimization parameters. In some implementations, optimizing the target power dissipation includes applying a hysteresis to limit a transition frequency between the enablement and disablement of the power dissipation mode, and wherein the applied hysteresis is based on the set of optimization parameters. In some implementations, the set of optimization parameters includes a weight of the electrified vehicle, a drive mode of the electrified vehicle, and an estimated duration of downhill travel by the electrified vehicle. In some implementations, the set of operating parameters includes a grade of a road that the electrified vehicle is on, an SOC of a high voltage battery system configured to supply electrical energy to at least one electric motor of the electrified powertrain, and a temperature of the friction brake system.

In some implementations, the set of operating parameters further includes a driver-controlled manual enablement request for the power dissipation mode, and wherein the controller is configured to enable the power dissipation mode without regard to a remainder of the set of operating parameters. In some implementations, the electrified vehicle is an FCEV and the electrified powertrain further includes a fuel cell system, and wherein the set of operating parameters includes a minimum power limit for generation by the fuel cell system. In some implementations, the minimum power limit for generation by the fuel cell system corresponds to hardware limits/constraints and/or durability concerns of the fuel cell system. In some implementations, the electrified vehicle is an REEV and the electrified powertrain further includes an internal combustion engine, and wherein the set of operating parameters and the set of power dissipation systems each include the engine and its motoring. In some implementations, the engine motoring takes priority over a remainder of the set of operating parameters for enablement of the power dissipation mode and for usage as a power dissipation system.

According to another example aspect of the invention, a control system for an electrified powertrain of an electrified vehicle is presented. In one exemplary implementation, the control system comprises a set of power dissipation systems each configured to operate and thereby dissipate electrical energy generated and/or stored by the electrified powertrain and a control system configured to determine whether to enable/disable a power dissipation mode of the electrified powertrain and, when the power dissipation mode is enabled, determine a torque request for the electrified powertrain based on a driver torque request and a set of negative torque requestors, determine a target power dissipation based on the determined torque request, a regenerative torque capability of a regenerative braking system of the electrified powertrain, and a set of operating parameters of the electrified vehicle, determine an allocation or distribution of the target power dissipation between the set of power dissipation systems, and control the set of power dissipation systems to achieve the target power dissipation and thereby reduce a thermal load on a friction brake system of the electrified vehicle.

In some implementations, the control system further comprises a set of optimizers configured to optimize the allocation or distribution of the target power dissipation among the set of power dissipation systems based on a regenerative torque capability of a regenerative braking system of the electrified powertrain, actual axle torques of the electrified powertrain, and states of the set of negative torque requestors and the set of power dissipation systems. In some implementations, the set of power dissipation systems includes one or more air-cooled resistors, inefficient operation of the regenerative braking system, and a set of other high voltage components of the electrified vehicle In some implementations, the electrified vehicle is an REEV and the set of power dissipation systems includes an internal combustion engine of the electrified powertrain. In some implementations, the engine takes priority over the remainder of the set of power dissipation systems for allocation/distribution of the target power dissipation, and wherein the engine is configured to be motored by other components of the electrified powertrain and cause power dissipation via engine pumping losses.

In some implementations, the set of negative torque requestors includes a brake torque request, an actual or driver-intended torque request, and a zero pedal or deceleration coast down torque request. In some implementations, the set of operating parameters includes a grade of a road that the electrified vehicle is on, an SOC of a high voltage battery system configured to supply electrical energy to at least one electric motor of the electrified powertrain, and a temperature of the friction brake system. In some implementations, the electrified vehicle is an FCEV and the set of negative torque requestors and the one or more operating parameters each include a minimum power generation limit for the fuel cell system of the electrified powertrain. In some implementations, the minimum power generation limit for the fuel cell system takes priority over a remainder of the set of operating parameters for determination of the target power dissipation. In some implementations, the control system is further configured to receive a manual request by a driver or operator of the electrified vehicle to enable the power dissipation mode, and wherein the manual request takes priority over other factors for the automated enablement/disablement of the power dissipation mode.

According to another example aspect of the invention, a control method for an electrified powertrain of an electrified vehicle is presented. In one exemplary implementation, the control method comprises determining, by a control system of the electrified vehicle, whether to enable/disable a power dissipation mode for the electrified powertrain and, when the power dissipation mode is enabled, determining, by the control system, a torque request for the electrified powertrain based on a driver torque request and a set of negative torque requestors, determining, by the control system, a target power dissipation based on the determined torque request, a regenerative torque capability of a regenerative braking system of the electrified powertrain, and a set of operating parameters of the electrified vehicle, determining, by the control system, an allocation or distribution of the target power dissipation between a set of power dissipation systems of the electrified vehicle, wherein each power dissipation system of the set of power dissipation systems is configured to operate and thereby dissipate electrical energy generated and/or stored by the electrified powertrain, and controlling, by the control system, the set of power dissipation systems to achieve the target power dissipation and thereby reduce a thermal load on a friction brake system of the electrified vehicle.

In some implementations, the control method further comprises optimizing, by a set of optimizers of the control system, the allocation or distribution of the target power dissipation among the set of power dissipation systems based on a regenerative torque capability of a regenerative braking system of the electrified powertrain, actual axle torques of the electrified powertrain, and states of the set of negative torque requestors and the set of power dissipation systems. In some implementations, the set of power dissipation systems includes one or more air-cooled resistors, inefficient operation of the regenerative braking system, and a set of other high voltage components of the electrified vehicle. In some implementations, the electrified vehicle is an REEV and the set of power dissipation systems includes an internal combustion engine of the electrified powertrain. In some implementations, the engine takes priority over the remainder of the set of power dissipation systems for allocation/distribution of the target power dissipation, and wherein the engine is configured to be motored by other components of the electrified powertrain and cause power dissipation via engine pumping losses.

In some implementations, the set of negative torque requestors includes a brake torque request, an actual or driver-intended torque request, and a zero pedal or deceleration coast down torque request. In some implementations, the set of operating parameters includes a grade of a road that the electrified vehicle is on, an SOC of a high voltage battery system configured to supply electrical energy to at least one electric motor of the electrified powertrain, and a temperature of the friction brake system. In some implementations, the electrified vehicle is an FCEV and the set of negative torque requestors and the one or more operating parameters each include a minimum power generation limit for the fuel cell system of the electrified powertrain. In some implementations, the minimum power generation limit for the fuel cell system takes priority over a remainder of the set of operating parameters for determination of the target power dissipation. In some implementations, the control method further comprises receiving, by the control system, a manual request by a driver or operator of the electrified vehicle to enable the power dissipation mode, wherein the manual request takes priority over other factors for the automated enablement/disablement of the power dissipation mode.

According to another example aspect of the invention, a control system for an electrified powertrain of an electrified vehicle is presented. In one exemplary implementation, the control system comprises a plurality of power dissipation systems each configured to operate and thereby dissipate electrical energy generated and/or stored by the electrified powertrain and a control system configured to determine whether to enable/disable a power dissipation mode of the electrified powertrain and, when the power dissipation mode is enabled, determine a target power dissipation based on a driver torque request and a set of operating parameters of the electrified vehicle, determine an allocation or distribution of the target power dissipation between a set of available power dissipation systems from the plurality of power dissipation systems, optimize the allocation or distribution of the target power dissipation between the set of power dissipation components, and control the available set of power dissipation systems based on the optimized allocation or distribution to achieve the target power dissipation and thereby reduce a thermal load on a friction brake system of the electrified vehicle.

In some implementations, the control system is further configured to determine states of the plurality of power dissipation systems and constraints or limits relative to the electrified powertrain. In some implementations, the electrified powertrain or limits include noise/vibration/harshness (NVH) constraints, temperature limits, and pressure limits. In some implementations, the control system is further configured to determine the set of available power dissipation systems and the allocation or distribution of the set of available power dissipation systems based on the states of the plurality of power dissipation systems and the electrified powertrain constraints or limits. In some implementations, the control system further comprises a set of optimizers configured to perform the optimization of the allocation or distribution of the target power dissipation between the set of available power dissipation systems.

In some implementations, the set of available power dissipation systems includes at least one of an electric heater, an electric fan, and an electric compressor or pump. In some implementations, the electrified vehicle is an FCEV comprising a fuel cell system that includes a fuel cell air compressor for pumping airflow through a fuel cell stack of the fuel cell system. In some implementations, the control system is configured to determine the target power dissipation based on a regenerative torque capability of a regenerative braking system of the electrified powertrain, an actual or driver-intended torque request, and a coast control torque request. In some implementations, the electrified vehicle is an FCEV and the control system is configured to determine the target power dissipation based on a minimum power generation limit for a fuel cell system of the electrified powertrain. In some implementations, the control system is further configured to optimize the target power dissipation based on a battery SOC, a grade of a road that the electrified vehicle is on, and a weight of the electrified vehicle.

According to yet another example aspect of the invention, a control method for an electrified powertrain of an electrified vehicle is presented. In one exemplary implementation, the control method comprises determining, by a control system of the electrified vehicle, whether to enable/disable a power dissipation mode for the electrified powertrain and, when the power dissipation mode is enabled, determining, by the control system a target power dissipation based on a driver torque request and a set of operating parameters of the electrified vehicle, determining, by the control system, an allocation or distribution of the target power dissipation between a set of available power dissipation systems from the plurality of power dissipation systems, optimizing, by the control system, the allocation or distribution of the target power dissipation between the set of power dissipation components, and controlling, by the control system, the available set of power dissipation systems based on the optimized allocation or distribution to achieve the target power dissipation and thereby reduce a thermal load on a friction brake system of the electrified vehicle.

In some implementations, the control method further comprises determining, by the control system, states of the plurality of power dissipation systems and constraints or limits relative to the electrified powertrain. In some implementations, the electrified powertrain constraints or limits include NVH constraints, temperature limits, and pressure limits. In some implementations, the control method further comprises determining, by the control system, the set of available power dissipation systems and the allocation or distribution of the set of available power dissipation systems based on the states of the plurality of power dissipation systems and the electrified powertrain constraints or limits. In some implementations, the control system further comprises a set of optimizers configured to perform the optimization of the allocation or distribution of the target power dissipation between the set of available power dissipation systems.

In some implementations, the set of available power dissipation systems includes at least one of an electric heater, an electric fan, and an electric compressor or pump. In some implementations, the electrified vehicle is an FCEV comprising a fuel cell system that includes a fuel cell air compressor for pumping airflow through a fuel cell stack of the fuel cell system. In some implementations, the determining of the target power dissipation is based on a regenerative torque capability of a regenerative braking system of the electrified powertrain, an actual or driver-intended torque request, and a coast control torque request. In some implementations, the electrified vehicle is an FCEV and the determining of the target power dissipation is based on a minimum power generation limit for a fuel cell system of the electrified powertrain. In some implementations, the control method further comprises optimizing, by the control system, the target power dissipation based on a battery SOC, a grade of a road that the electrified vehicle is on, and a weight of the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle (EV) having an example electrified powertrain system according to the principles of the present application;

FIG. 2A is a functional block diagram of an example configuration of the electrified powertrain system for a fuel cell EV (FCEV) according to the principles of the present application;

FIG. 2B is a functional block diagram of an example configuration of the electrified powertrain system for a range-extended EV (REEV) according to the principles of the present application;

FIG. 3A is a functional block diagram of an example configuration of a power dissipation control system for an EV according to the principles of the present application;

FIG. 3B illustrates diagrams of example power dissipation and thermal control during a downhill scenario including a corresponding power dissipation parameter plot according to the principles of the present application;

FIGS. 4A-4C are functional block diagrams of example configurations of various sub-systems of the control system according to the principles of the present application;

FIGS. 5A-5G illustrate example plots of power dissipation parameters and power dissipation enable state versus time according to the principles of the present application; and

FIGS. 6A-6C are flow diagrams of example power dissipation mode enablement/disablement and control methods for an electrified powertrain of an EV according to the principles of the present application.

### DESCRIPTION

As previously discussed, for heavy-duty electrified vehicle applications in particular, such as heavy-duty pickup trucks that are capable of towing significant payloads, there is a desire to minimize the usage of conventional friction brakes (e.g., during downhill driving) to extend their life/usability. This is typically achieved by instead utilizing regenerative braking to recapture the vehicle's kinetic energy. In some scenarios, however, the energy storage system is “full” or at its capacity and thus regenerative braking cannot be utilized. Adding additional energy storage systems (capacitors, battery systems, etc.) or large resistor banks significantly increases vehicle weight and costs. Thus, there remains an opportunity for improvement in the relevant art. Accordingly, improved control systems and methods for electrified powertrains of EVs are presented herein. These control systems/methods involve unique power dissipation control strategies, which is also referred to as electrical burn or “e-burn.” These processes involve intentionally dissipating the power recaptured by an EV's regenerative braking system during extended downhill operation in order to mitigate a thermal load on the EV's conventional friction brakes. Potential benefits of these new techniques include increased EV component (e.g., friction brake system) life/usability and avoiding the increased weight/costs associated with other conventional solutions to this problem as disused above.

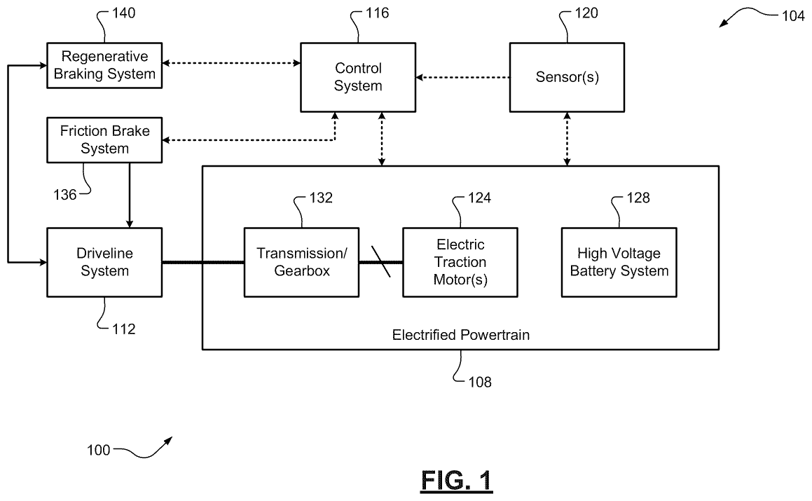

Referring now to FIG. 1, a functional block diagram of an EV 100 (also referred to herein as “vehicle 100”) having an example electrified powertrain system 104 according to the principles of the present application is illustrated. The electrified powertrain system 104 generally comprises an electrified powertrain 108 configured to generate and transfer drive torque to a driveline system 112 for vehicle propulsion, and a controller or control system 116 and a set of one or more sensors 120 for controlling the electrified powertrain. The electrified powertrain 108 generally comprises one or more electric motors 124 (also referred to as “electric traction motor(s) 124” as they generate drive torque) that are powered by electrical energy (i.e., current) from a high voltage battery system 128. The drive torque generated by the electric motor(s) 124 is transferred to the driveline system 112 via a transmission/gearbox 132 or another suitable torque transfer system. A conventional friction brake system 136 (e.g., hydraulic friction brakes) are configured to provide frictional braking force to decelerate the driveline system 136. A regenerative braking system 140 is similarly configured to decelerate the driveline system 112, but the regenerative braking system 140 achieves this through the use of one or more electric motors (not shown) that act as a torque consumer or negative load on the driveline system 112. Non-limiting examples of the sensor(s) 120 include a driver interface (accelerator/brake pedals, transmission gear shift lever, start/stop button, power dissipation enable/disable button, etc.), powertrain/driveline shaft speed sensors, and component temperature/pressure sensors. Other operating parameters, such battery system state of charge (SOC), could be modeled or estimated based on other parameters rather than directly measured by the sensor(s) 120.

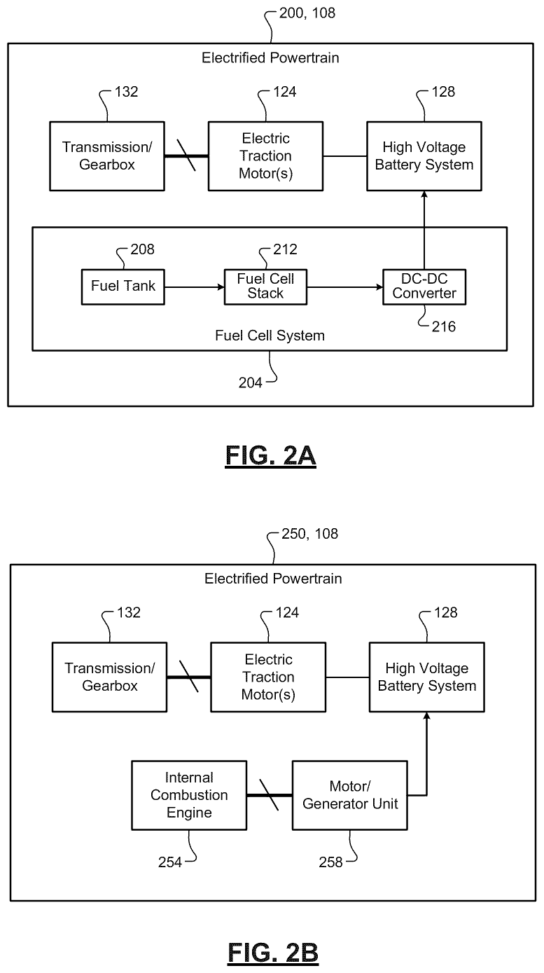

Referring now to FIGS. 2A-2B, two specific example configurations 200, 250 of the electrified powertrain 108 according to the principles of the present application are illustrated. In FIG. 2A, a fuel cell EV (FCEV) configuration 200 of the electrified powertrain 108 is illustrated. As shown, the electrified powertrain 108 further includes a fuel cell system 204 comprising a fuel tank 208, a fuel cell stack 212, and a DC-DC converter 216. In one exemplary implementation, the fuel cell system 204 is a hydrogen (H2) fuel cell system and the fuel tank stores hydrogen (H2) fuel. It will be appreciated that the fuel cell system 204 could further include other non-illustrated components and could also be another type of (i.e., a different fuel type) fuel cell system. In FIG. 2B, a range-extended EV (REEV) configuration 250 (also referred to as a range-extended paradigm breaker, or “REPB configuration 250”) of the electrified powertrain 108 is illustrated. As shown, the electrified powertrain 108 further includes an internal combustion engine 254 and a motor/generator unit (MGU) 258. The engine 254 is configured to combust a mixture of air and liquid fuel (gasoline, diesel, etc.) within cylinders to drive pistons that rotatably turn a crankshaft and generate drive torque. The engine 254 provides this drive torque to the MGU 258 for electrical energy conversion/generation (e.g., for recharging the battery system 124).

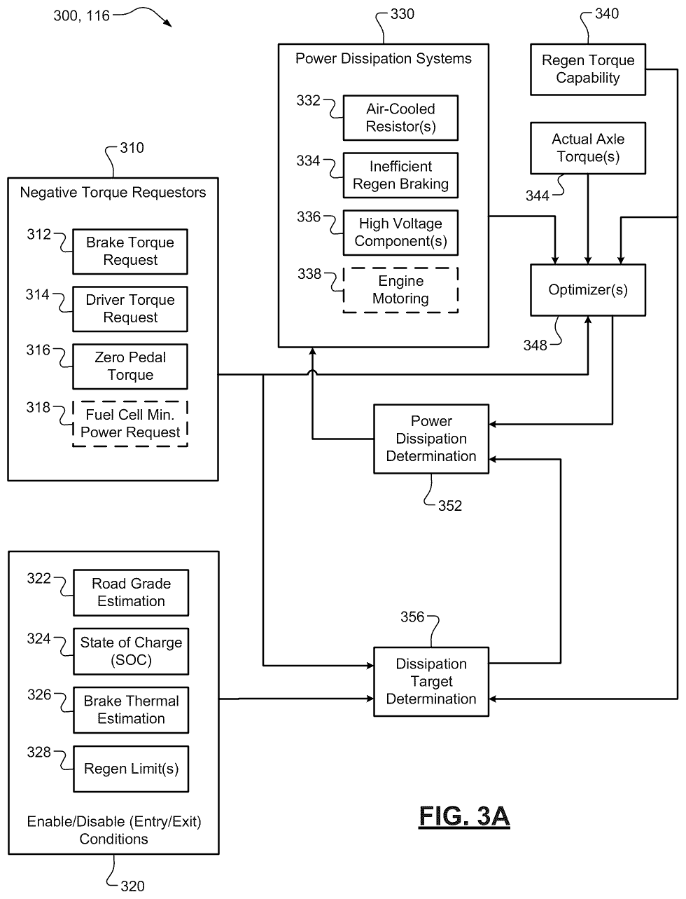

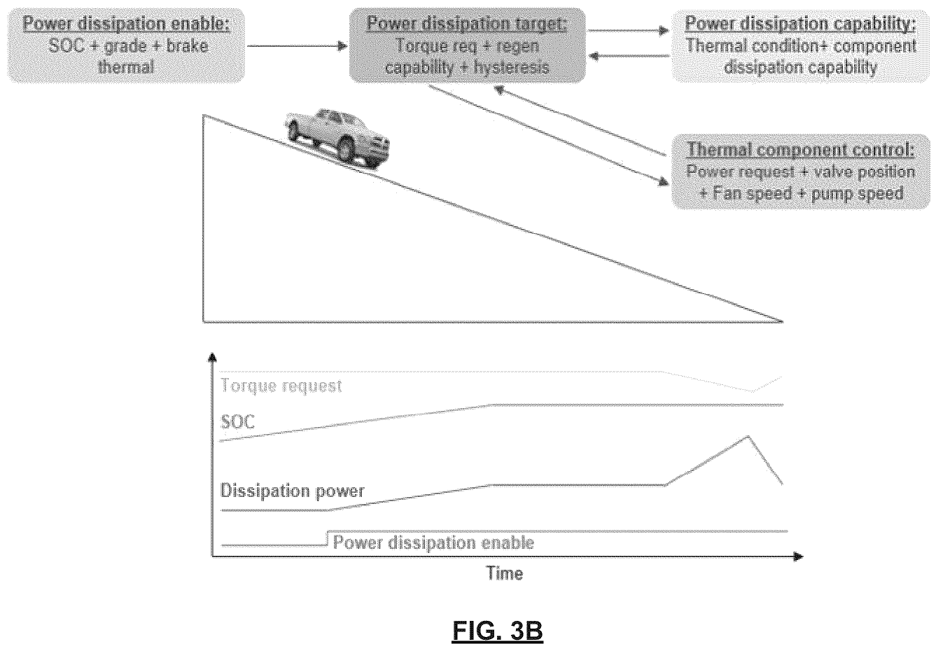

Referring now to FIG. 3A, a functional block diagram of an example configuration 300 of the control system 116 for power dissipation control according to the principles of the present application is illustrated. This also represents a high-level or overall configuration of the control system 116 for purposes of the present application. The process is generally divided into the following sub-processes or procedures: (1) torque request determination/arbitration (e.g., arbitrate negative torque request between driver brake request, zero pedal deceleration torque request, and the like); (2) power consumption/dissipation system capability determination (e.g., estimate available power dissipation capability and calculate current power consumption value for each device/system); (3) optimization (e.g., determine how to dissipate energy based on power dissipation capability and torque request); (4) power dissipation entry/exit conditions (e.g., enable or disable power dissipation based on road grade, battery SOC, friction brake thermal condition, regen limitation, and so on); (5) power dissipation target determination (e.g., calculate the total power dissipation required based on torque request and regen capability); and, lastly, (6) power dissipation determination (execution of power dissipation target for each system).

As shown, the negative torque requestors 310 could include a brake torque request 312, a driver torque request (or driver-intended torque) 314, a zero pedal request 316 (e.g., an accelerator pedal not depressed, which could involve cruise control operation or the vehicle decelerating or coasting-down), and, for FCEV applications, a fuel cell minimum power request 318. This fuel cell minimum power request 318 represents a minimum power request that the fuel cell system 204 could be set for due to operational limits/constraints of the fuel cell system 204 and the desire to not very frequently startup/shutdown the fuel cell system 204 during a current vehicle key-cycle event due to hardware limits and durability considerations. These negative torque requests are fed to a dissipation target determination 356, and also could be provided to power dissipation optimizer(s) 348. Another source of input for the dissipation target determination 356 is various enable/disable (e.g., entry/exit) conditions 320. As shown, these enable/disable conditions 320 include a road grade estimation 322, an SOC of the battery system 124, a thermal/temperature estimation 326 of the friction brake system 136, and regeneration limit(s) 328. In another portion of the control system 300, a power dissipation determination 352 is performed. This power dissipation determination 352 involves assigning or allocating the optimized power dissipation among a set of power dissipation systems 330.

As shown, the power dissipation systems 330 include one or more air-cooled resistors 332, inefficient operation/control of the regenerative braking system 140 (referred to as 334), high voltage components 336 (e.g., other high voltage components of the EV 100), and, for REEV/REPB applications, engine motoring 338 (e.g., pumping losses of the engine 254). This engine motoring 338, for example, represents a very significant source of power dissipation and thus is preferable to utilize as much as possible in REEV/REPB applications. The optimizer(s) 348 monitor the operation of the power dissipation systems 330, as well as a regenerative torque capability 340 (e.g., associated with the regenerative braking system 140) and actual axle torques 344 of the vehicle 100. The optimizer(s) 348 are configured to optimize or adjust the operation of these power dissipation systems 330 to achieve desired power dissipation within a set of hardware limits/constraints. The power dissipation determination 352 receives the total power dissipation target from dissipation target determination 356, and then controls power dissipation system(s) 330 based on respective individual power dissipation targets in any suitable manner (open-loop or feedforward, closed-loop feedback based on error/difference, etc.). One goal/target of these techniques is to provide constant/expected deceleration feel of the EV 100 when traveling downhill, which is discussed in greater detail below.

FIG. 3B illustrates diagrams of example power dissipation and thermal control during a downhill scenario including a corresponding power dissipation parameter plot according to the principles of the present application. As shown, the EV 100 has a heavy-duty pickup truck configuration and is traveling down a constant grade for an extended future period. The block diagram at the top of FIG. 3B illustrates various example operations occurring during the operation of the EV 100, including power dissipation enable determination, power dissipation target determination, power dissipation capability determination, and thermal component (power dissipation system) control. The plot at the bottom of FIG. 3B illustrates some of these parameters of the electrified powertrain 108 during the operation of the EV 100 as described. As shown, the torque request initially remains constant and the battery SOC is increasing (due to regenerative braking). Once the power dissipation mode is enabled, the dissipation power increases and eventually flattens out once the battery SOC does as well (e.g., when the battery SOC reaches its maximum value/threshold). After this, the negative torque request increases (brake pedal-on or further depressed, vehicle reaching a steeper downhill grade, etc.), which in turn causes a spike in the dissipation power that is handled by the power dissipation techniques.

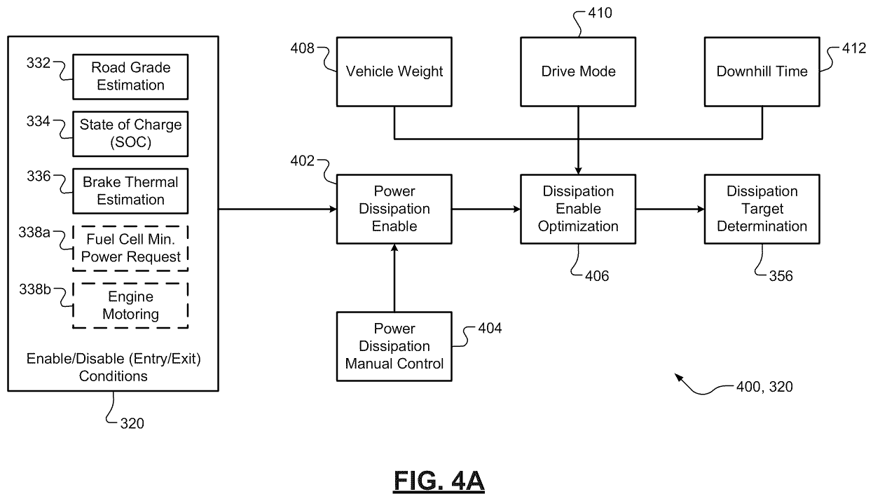

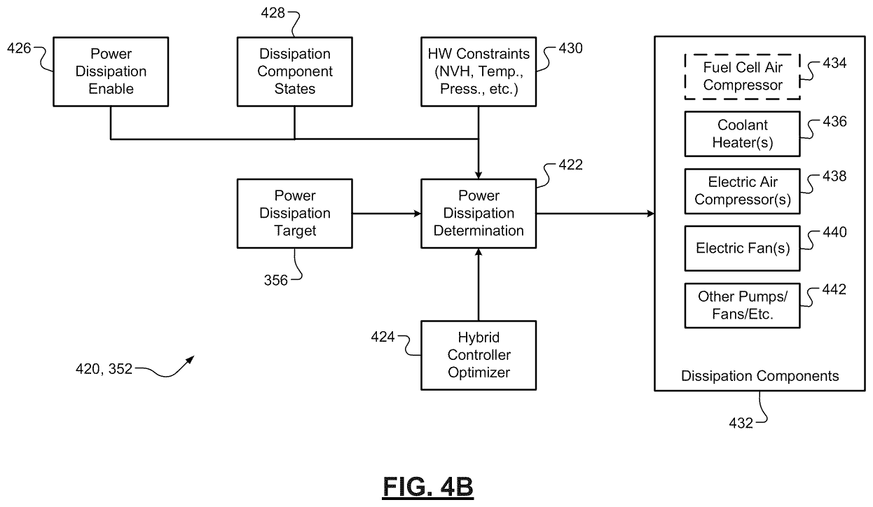

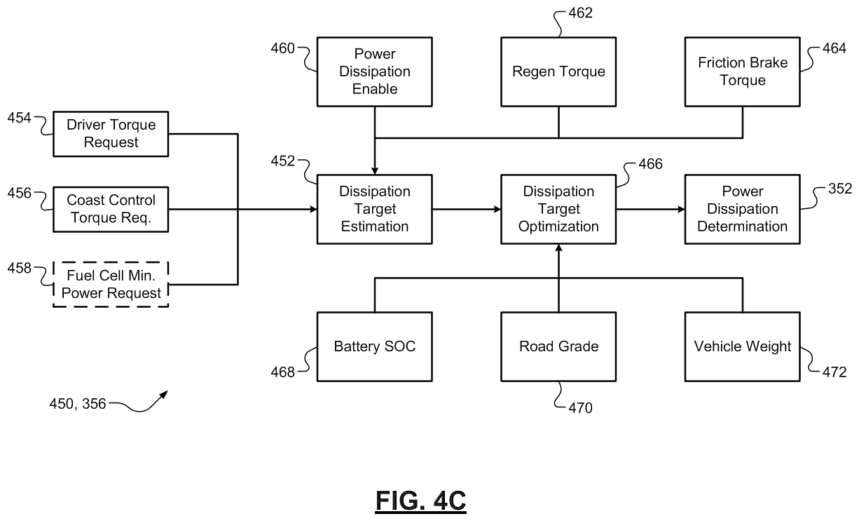

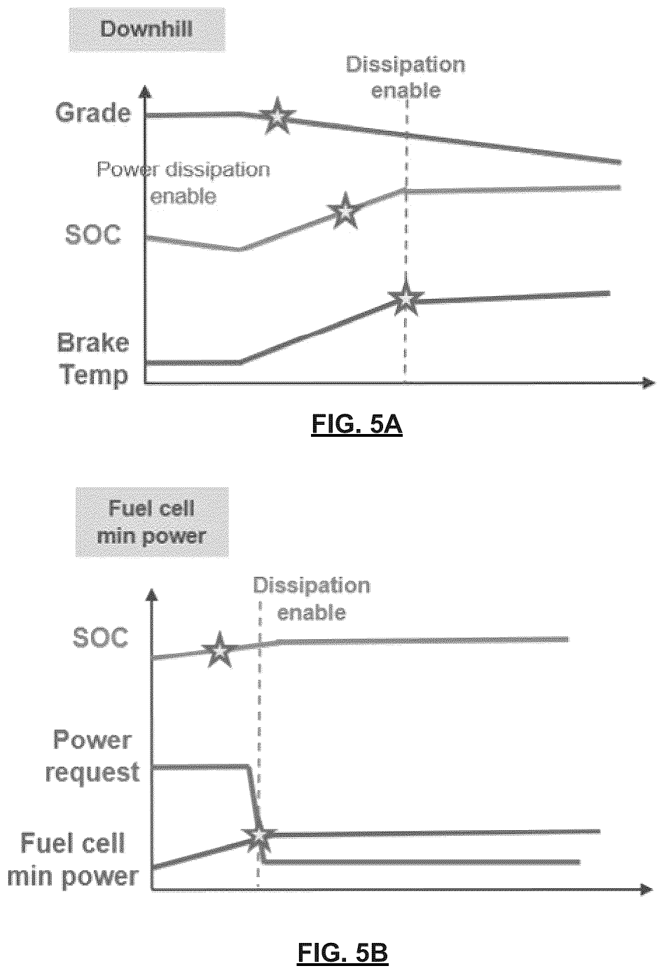

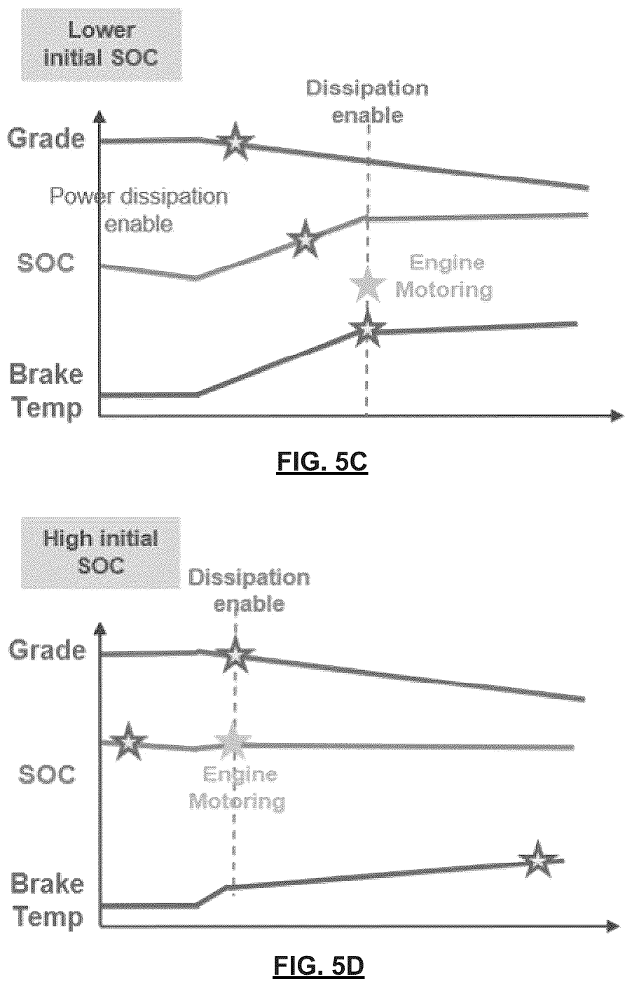

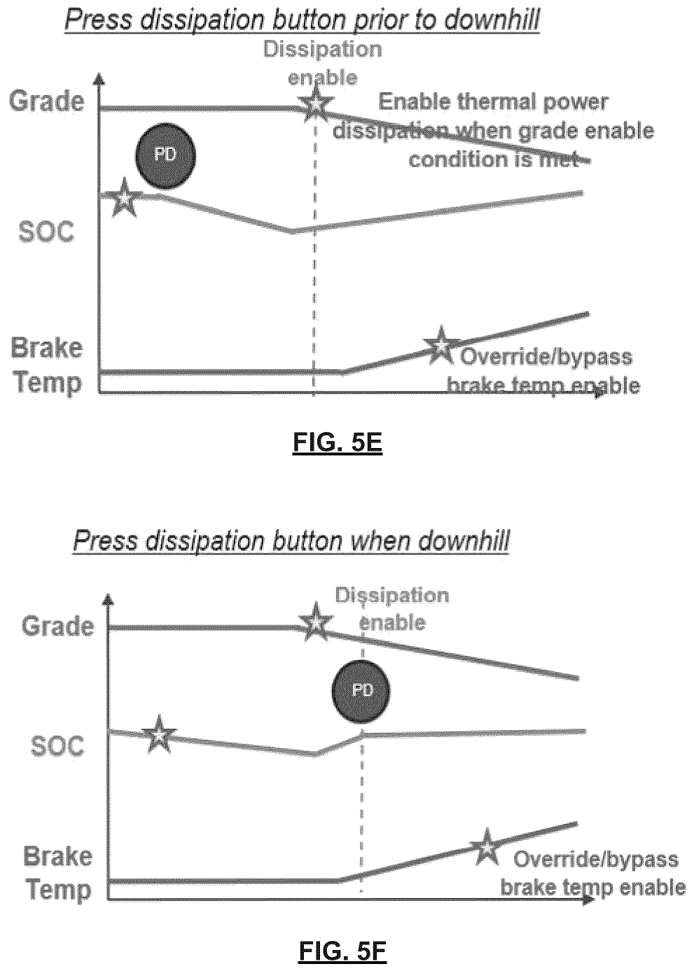

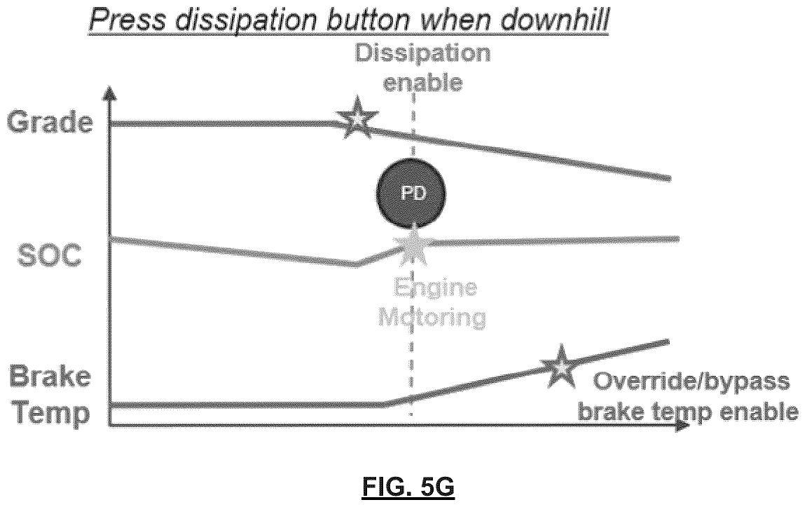

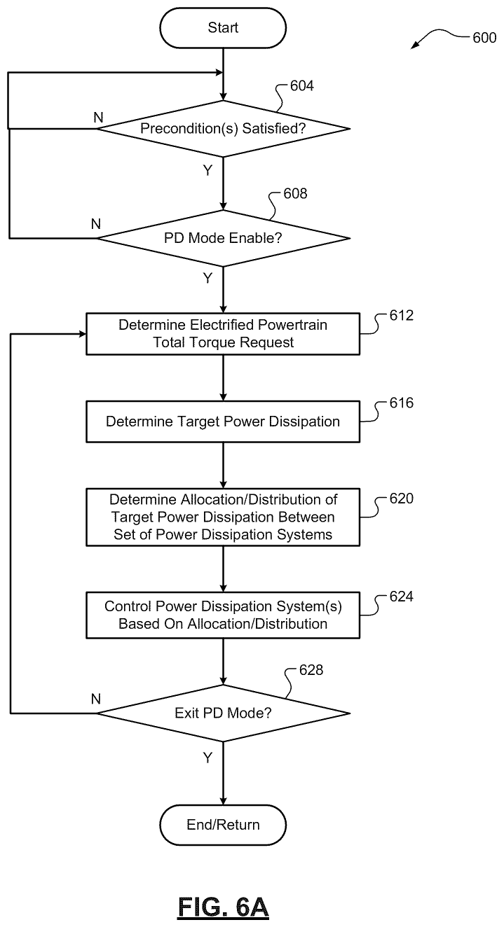

Referring now to FIGS. 4A,-4C, functional block diagrams of configurations of various sub-systems of the control system 300, 116 (see FIG. 3A) according to the principles of the present application are illustrated in greater detail. FIGS. 5A-5G also include plots (similar to the bottom plot of FIG. 3B) that illustrate the various parameters of the EV 100 during the operation of these sub-systems of FIGS. 4A-4C. In FIG. 4A, an example configuration 400 of the enable/disable (entry/exit) conditions 320 of the control system 300 is illustrated in greater detail. Weight variation (i.e., different loadings and different vehicle size/weight trailers) is a significant parameter in the techniques of the present application. Accordingly, the power dissipation enable conditions change significantly with various weights, slope grade, battery SOC and the like. Enabling power dissipation too early causes wasted energy and efficiency losses, while enabling power dissipation too late enable can impact drivability performance and customer satisfaction. Additionally, frequent enable and disable power dissipation (poor enable strategy) reduces hardware life and causes noise/vibration/harshness (NVH) and drivability issues. The present application develops a power dissipation enable strategy to achieve optimized power dissipation amount and stable/smooth power dissipation operations.

This power dissipation enable strategy (1) efficiently enables power dissipation to achieve vehicle drivability performance without over-temperature conditions for the friction brake system 136; and (2) for FCEV applications, enable power dissipation to dissipate energy generated from a fuel cell system 204, including optimizing power dissipation operation (when to start/stop) to avoid unnecessary hardware frequently dynamic operational condition changes. This power dissipation enable 402 is based on estimated, measured, or known road grade 332, battery SOC 334, brake thermal estimation, 336, fuel cell power 338 (FCEV-only), and engine motoring (REEV/REPB only). Additionally or alternatively, the power dissipation mode could be manually enabled by a driver of the EV 100, such as using a power dissipation mode manual control 404 (a switch/button, a user-interface selectable option, etc.). For example, this could allow the driver of the EV 100 to operate the power dissipation mode similar to an exhaust brake on a conventional diesel vehicle, which could be particularly useful or desirable for drivers having past experience with such vehicles/features. Additional inputs, such as vehicle weight 408, powertrain drive mode 410 (EV-only, engine only, series or parallel hybrid, etc.), and downhill time 412 are used for the power dissipation enable strategy optimization by the dissipation enable optimizer 406.

For example, when the vehicle 100 is going downhill, road grade, battery SOC and friction brake temperature are utilized together to trigger power dissipation enable as shown in FIG. 5A. For fuel cell power dissipation cases (FCEV-only), when the fuel cell system 204 is turned on, it operates at a value greater than a minimum power level/threshold. When battery SOC is high (limited recharge), and the vehicle power request drops (e.g. stopped at traffic light), power dissipation is enabled to absorb this fuel cell minimum power as shown in FIG. 5B. If the initial SOC is relatively low and road grade/SOC/friction brake temperature enables power dissipation first, the strategy enables engine motoring (REEV/REPB only) at the same time as shown in FIG. 5C. If initial SOC is high, engine motoring and power dissipation are enabled at the same time (i.e., engine motoring triggers power dissipation) as shown in FIG. 5D. Friction brake temperature (as an enable condition/input) is thereby bypassed, and power dissipation remains enabled. The power dissipation manual control (e.g., switch/button) can also be used to manually enable power dissipation. For example, the power dissipation manual control could enable engine motoring power dissipation first. If the vehicle is not traveling downhill, the power dissipation mode could “pre-consume” energy for the upcoming downhill operation as shown in FIG. 5E. Also shown in FIG. 5E, when the vehicle 100 is descending on the downhill grade, other power dissipation components are kicked in to increase dissipation power. If the power dissipation manual control is actuated (e.g., pressed) while the vehicle 100 is already traveling downhill, engine motoring and power dissipation components are enabled for dissipation as shown in FIG. 5F. Again, this is similar to a driver/user controllable exhaust brake feature for heavy duty truck applications.

Referring now to FIG. 4B, an example configuration 420 of the power dissipation determination 352 of the control system 300 is illustrated in greater detail. As previously mentioned, there are many components (systems/devices) that could be used for power dissipation. Some of these components may be part of the same thermal loop whereas some of the components may be part of different thermal loops. The specifics of how to control each of these components to achieve the requested power dissipation target requires a comprehensive management strategy to coordinate the entire system inside the hardware, NVH and thermal constraints. The techniques of the present application present a power dissipation management system to arbitrate usage of different power dissipation components (e.g. to use the power dissipation components, shown in FIG. 4B as 432) to optimize dissipation system performance. The power dissipation determination 422 begins by gathering or collecting the power dissipation target 356, the power dissipation enable state 426, the power dissipation component states 428, and a set of hardware (HW) constraints, such as NVH, temperature, and pressure limits of the electrified powertrain 108. The power dissipation determination 422 also communicates with the optimizers 348, shown here as a hybrid controller optimizer 424, to help optimally allocate/distribute the total power dissipation target 356 amongst a plurality of power dissipation components 432. These power dissipation components 432 could include, for example only, a fuel cell air compressor 434 (FCEV-only) that pumps air through a fuel cell stack 212 (e.g., H2 fuel cell stack), coolant heaters 436, electric air compressors 438, electric fans 440, and any other fans/pumps/load devices 442, and so on.

Referring now to FIG. 4C, an example configuration 450 of the power dissipation target determination 356 of the control system 300 is illustrated in greater detail. As previously mentioned, the target power dissipation power changes significantly with various weights, slope grade, and regeneration capabilities. It could be ideal to only dissipate as much power as needed; i.e., more power dissipation than is needed causes energy waste and efficiency loss, whereas less power dissipation than is needed could negatively impact drivability performance and customer satisfaction. The techniques of the present application therefore employ an optimization strategy for the power dissipation target to minimize energy loss without reducing power dissipation performance. This procedure could be generally divided into the following sub-steps or processes: (1) during power dissipation enable 460, determine or estimate the power dissipation target at 452 based on a driver torque request 454, a deceleration or coast control torque request 456, (FCEV-only) a minimum power request by the fuel cell system 458, regenerative braking torque 462, and friction brake torque 464 to minimize power dissipation waste; (2) use the battery SOC 468, road slope/grade 470, vehicle weight 472, and any other suitable information additional information to optimize the power dissipation target ay 466 to achieve more stable power dissipation control and better drivability performance. Finally, the optimized power dissipation target could be utilized by the power dissipation determination 352 to best allocate/distribute the power dissipation between the various power dissipation components to achieve this optimized target power dissipation.

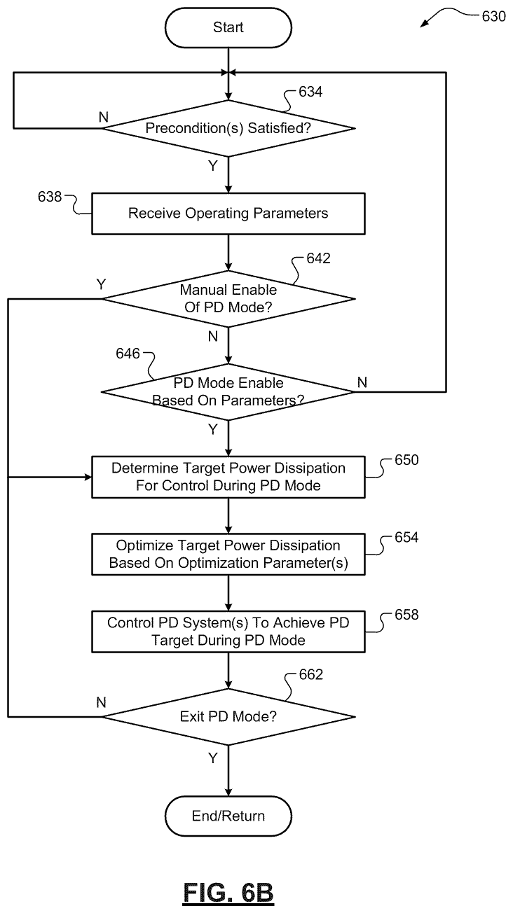

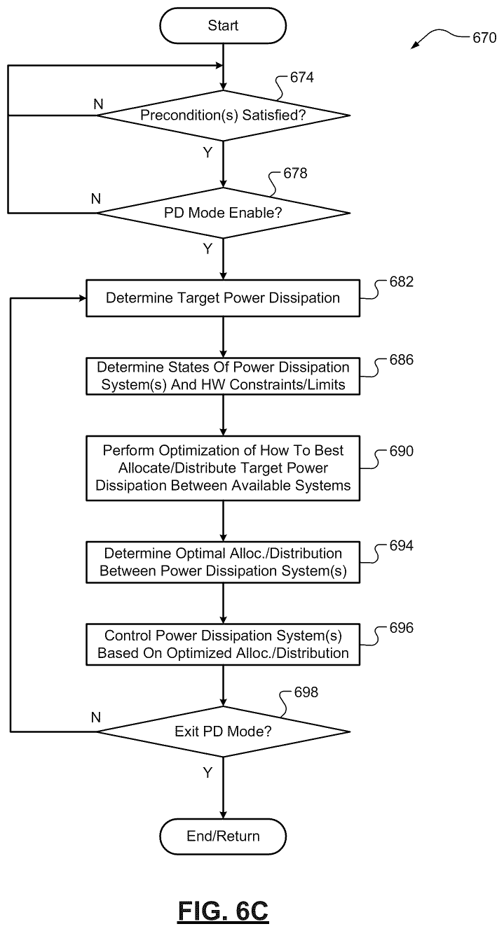

Referring now to FIGS. 6A-6C, flow diagrams of example power dissipation mode enablement/disablement and control methods 600, 630, and 660 for an electrified powertrain of an EV according to the principles of the present application are illustrated. In FIG. 6A, a flow diagram of an example method 600 for the overall or general control of a power dissipation (PD) mode of an electrified vehicle is illustrated. While some of the components previously shown and/or described herein may be referenced for illustrative/descriptive purposes, it will be appreciated that this method 600 could be applicable to any suitably-configured electrified vehicle (FCEV, REEV/REPB, etc.). At 604, the control system 116 determines whether a set of one or more optional preconditions are satisfied. These precondition(s) could include, for example only, the electrified vehicle 100 being powered up and in a drive-ready mode and there being no malfunctions or faults present that would otherwise inhibit or negatively impact the operation of the techniques of the present application. When false, the method 630 ends or returns to 604. When true, the method 600 proceeds to 608. At 608, the control system 116 determines whether the PD mode is enabled. This could be either via a manual driver enablement (e.g., via a switch/button) or via an automated determination by the control system 116 that the PD mode is needed. When false, the method 600 ends or returns to 604. When true, the method 600 proceeds to 612.

At 612, the control system 116 determines a total torque request for the electrified powertrain 108. This could include, for example, a combination of a driver requested or driver-intended torque and a sum of all negative torque requests from a set of negative torque requestors (brake torque, cruise or coast down torque, zero pedal or deceleration torque, a fuel cell system minimum power generation for FCEV-only, etc.). At 616, the control system 116 determines the target power dissipation, which could be based, for example, on the determined total torque request, a regenerative torque capability of a regenerative braking system 140, and a set of operating parameters (e.g., from sensor(s) 120). At 620, the control system 116 determines an allocation or distribution of the target power dissipation between the set of power dissipation systems. At 624, the control system 116 controls the set of power dissipation systems based on the determined allocation or distribution of the target power dissipation such that the set of power dissipation systems collectively dissipate and achieve the target power dissipation. At 628, the control system 116 determines whether to exit the PD mode, such as when a set of exit conditions are satisfied (i.e., indicating that PD mode is no longer necessary). When false, the method 600 returns to 612. When true, the method 600 ends or returns to 604.

Referring now to FIG. 6B, a flow diagram of an example method 630 for controlling enablement/disablement (entry/exit) of a power dissipation (PD) mode of an electrified vehicle is illustrated. While some of the components previously shown and/or described herein may be referenced for illustrative/descriptive purposes, it will be appreciated that this method 630 could be applicable to any suitably-configured electrified vehicle (FCEV, REEV/REPB, etc.). At 634, the control system 116 determines whether a set of one or more optional preconditions are satisfied. These precondition(s) could include, for example only, the electrified vehicle 100 being powered up and in a drive-ready mode and there being no malfunctions or faults present that would otherwise inhibit or negatively impact the operation of the techniques of the present application. When false, the method 630 ends or returns to 634. When true, the method 630 proceeds to 638. At 638, the control system 116 receives the operating parameters (relating to enablement/disablement of the PD mode) from the set of sensors 120. At 642, the control system 116 determines whether a manual (driver) request to enable the PD mode has been received (e.g., via the power dissipation manual control 404). This manual/driver control of the PD mode entry/exit via a simple switch/button or other user interface device is similar to a conventional exhaust brake feature on a heavy-duty vehicle such as a diesel-powered pickup truck. When true, the method 630 proceeds to 650. When false, the method 630 proceeds to 646.

At 646, the control system 116 determines whether to enable the PD mode based on the set of operating parameters (e.g., from sensor(s) 120) relating to PD mode enablement/disablement. These parameters could include, for example, estimated road grade, battery SOC, estimated friction brake temperature, minimum fuel cell system power generation (FCEV-only), and engine motoring (REEV/REPB-only). When false, the method 630 ends or returns to 634. When true, the method 630 proceeds to 650. At 650, the control system 116 determines the target power distribution for use/control during the PD mode based on a set of operating parameters (regenerative torque capability, friction brake torque/temperature, driver/coast torque requests, fuel cell system minimum power generation for FCEV-only, etc.). At 654, the control system 116 optimizes the target power distribution based on a set of optimization parameters (road grade, battery SOC, vehicle weight, etc.). At 658, the control system 116 controls the set of power dissipation systems based on the optimized target power dissipation such that the power dissipation systems collectively dissipate and achieve the optimized target dissipation and thereby reduce or mitigate the thermal load on the friction brake system 136. At 658, the control system 116 determines whether to exit the PD mode, such as when a set of exit conditions are satisfied (i.e., indicating that PD mode is no longer necessary). When false, the method 630 returns to 650. When true, the method 630 ends or returns to 634.

Referring now to FIG. 6C, a flow diagram of an example method 670 for the optimizing the allocation/distribution of power dissipation between a set of power distribution systems during a power dissipation (PD) mode of an electrified vehicle is illustrated. While some of the components previously shown and/or described herein may be referenced for illustrative/descriptive purposes, it will be appreciated that this method 670 could be applicable to any suitably-configured electrified vehicle (FCEV, REEV/REPB, etc.). At 674, the control system 116 determines whether a set of one or more optional preconditions are satisfied. These precondition(s) could include, for example only, the electrified vehicle 100 being powered up and in a drive-ready mode and there being no malfunctions or faults present that would otherwise inhibit or negatively impact the operation of the techniques of the present application. When false, the method 670 ends or returns to 674. When true, the method 670 proceeds to 678. At 608, the control system 116 the control system 116 determines whether the PD mode is enabled. This could be either via a manual driver enablement (e.g., via a switch/button) or via an automated determination by the control system 116 that the PD mode is needed. When false, the method 670 ends or returns to 674. When true, the method 670 proceeds to 682.

At 682, the control system 116 determines the target power dissipation as previously described herein. At 686, the control system 116 determines states of the set of power dissipation systems and hardware (HW) constraints or limits relative to the electrified powertrain 108 during PD mode operation (NVH, temperature limits, pressure limits, etc.). At 690, the control system 116 performs optimization of how to best (i.e., most optimally) allocate or distribute the target power dissipation between the set of power dissipation systems (coolant heater(s), electric air compressors, electric fans, electric pumps, a fuel cell system air compressor for FCEV-only, etc.) based on their states, the HW constraints, and other hybrid optimization factors for the electrified powertrain 108. At 694, the control system 116 determines an optimal allocation or distribution of the target power dissipation between the set of power dissipation systems based the results of the previous optimization process. At 696, the control system 116 controls the set of power dissipation systems based on the optimized allocation or distribution of the target power dissipation therebetween to thereby reduce or mitigate the thermal load on the friction brake system 136. At 698, the control system 116 determines whether to exit the PD mode, such as when a set of exit conditions are satisfied (i.e., indicating that PD mode is no longer necessary). When false, the method 670 returns to 682. When true, the method 670 ends or returns to 674.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an electrified powertrain of an electrified vehicle, the control system comprising:
a set of power dissipation systems each configured to operate and thereby dissipate electrical energy generated and/or stored by the electrified powertrain; and
a control system configured to determine whether to enable/disable a power dissipation mode of the electrified powertrain and, when the power dissipation mode is enabled:
determine a torque request for the electrified powertrain based on a driver torque request and a set of negative torque requestors;
determine a target power dissipation based on the determined torque request, a regenerative torque capability of a regenerative braking system of the electrified powertrain, and a set of operating parameters of the electrified vehicle;
determine an allocation or distribution of the target power dissipation between the set of power dissipation systems; and
control the set of power dissipation systems to achieve the target power dissipation and thereby reduce a thermal load on a friction brake system of the electrified vehicle.

2. The control system of claim 1, wherein the control system further comprises a set of optimizers configured to optimize the allocation or distribution of the target power dissipation among the set of power dissipation systems based on a regenerative torque capability of a regenerative braking system of the electrified powertrain, actual axle torques of the electrified powertrain, and states of the set of negative torque requestors and the set of power dissipation systems.

3. The control system of claim 2, wherein the set of power dissipation systems includes one or more air-cooled resistors, inefficient operation of the regenerative braking system, and a set of other high voltage components of the electrified vehicle.

4. The control system of claim 3, wherein the electrified vehicle is a range-extended electrified vehicle (REEV) and the set of power dissipation systems includes an internal combustion engine of the electrified powertrain.

5. The control system of claim 4, wherein the engine takes priority over the remainder of the set of power dissipation systems for allocation/distribution of the target power dissipation, and wherein the engine is configured to be motored by other components of the electrified powertrain and cause power dissipation via engine pumping losses.

6. The control system of claim 1, wherein the set of negative torque requestors includes a brake torque request, an actual or driver-intended torque request, and a zero pedal or deceleration coast down torque request.

7. The control system of claim 6, wherein the set of operating parameters includes a grade of a road that the electrified vehicle is on, a state of charge (SOC) of a high voltage battery system configured to supply electrical energy to at least one electric motor of the electrified powertrain, and a temperature of the friction brake system.

8. The control system of claim 7, wherein the electrified vehicle is a fuel cell electrified vehicle (FCEV) and the set of negative torque requestors and the one or more operating parameters each include a minimum power generation limit for the fuel cell system of the electrified powertrain.

9. The control system of claim 7, wherein the minimum power generation limit for the fuel cell system takes priority over a remainder of the set of operating parameters for determination of the target power dissipation.

10. The control system of claim 1, wherein the control system is further configured to receive a manual request by a driver or operator of the electrified vehicle to enable the power dissipation mode, and wherein the manual request takes priority over other factors for the automated enablement/disablement of the power dissipation mode.

11. A control method for an electrified powertrain of an electrified vehicle, the control method comprising:
determining, by a control system of the electrified vehicle, whether to enable/disable a power dissipation mode for the electrified powertrain; and
when the power dissipation mode is enabled:
determining, by the control system, a torque request for the electrified powertrain based on a driver torque request and a set of negative torque requestors;
determining, by the control system, a target power dissipation based on the determined torque request, a regenerative torque capability of a regenerative braking system of the electrified powertrain, and a set of operating parameters of the electrified vehicle;
determining, by the control system, an allocation or distribution of the target power dissipation between a set of power dissipation systems of the electrified vehicle, wherein each power dissipation system of the set of power dissipation systems is configured to operate and thereby dissipate electrical energy generated and/or stored by the electrified powertrain; and
controlling, by the control system, the set of power dissipation systems to achieve the target power dissipation and thereby reduce a thermal load on a friction brake system of the electrified vehicle.

12. The control method of claim 11, further comprising optimizing, by a set of optimizers of the control system, the allocation or distribution of the target power dissipation among the set of power dissipation systems based on a regenerative torque capability of a regenerative braking system of the electrified powertrain, actual axle torques of the electrified powertrain, and states of the set of negative torque requestors and the set of power dissipation systems.

13. The control method of claim 12, wherein the set of power dissipation systems includes one or more air-cooled resistors, inefficient operation of the regenerative braking system, and a set of other high voltage components of the electrified vehicle.

14. The control method of claim 13, wherein the electrified vehicle is a range-extended electrified vehicle (REEV) and the set of power dissipation systems includes an internal combustion engine of the electrified powertrain.

15. The control method of claim 14, wherein the engine takes priority over the remainder of the set of power dissipation systems for allocation/distribution of the target power dissipation, and wherein the engine is configured to be motored by other components of the electrified powertrain and cause power dissipation via engine pumping losses.

16. The control method of claim 11, wherein the set of negative torque requestors includes a brake torque request, an actual or driver-intended torque request, and a zero pedal or deceleration coast down torque request.

17. The control method of claim 16, wherein the set of operating parameters includes a grade of a road that the electrified vehicle is on, a state of charge (SOC) of a high voltage battery system configured to supply electrical energy to at least one electric motor of the electrified powertrain, and a temperature of the friction brake system.

18. The control method of claim 17, wherein the electrified vehicle is a fuel cell electrified vehicle (FCEV) and the set of negative torque requestors and the one or more operating parameters each include a minimum power generation limit for the fuel cell system of the electrified powertrain.

19. The control method of claim 17, wherein the minimum power generation limit for the fuel cell system takes priority over a remainder of the set of operating parameters for determination of the target power dissipation.

20. The control method of claim 19, further comprising receiving, by the control system, a manual request by a driver or operator of the electrified vehicle to enable the power dissipation mode, wherein the manual request takes priority over other factors for the automated enablement/disablement of the power dissipation mode.
